(19) United States
(12) Patent Application Publication
(10) Pub. No.: US 2005/0231653 A1
(43) Pub. Date: Oct. 20, 2005

(54) CRT type digital television

(75) Inventors: Toshihiro Nakakura, Takefu-city (JP); Kazuhiro Hosojima, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/091,382

(22) Filed: Mar. 29, 2005

(30) Foreign Application Priority Data
Mar. 31, 2004 (JP) 2004-102166

(51) Int. Cl. H04N 5/64

(52) U.S. Cl. 348/836

(57) ABSTRACT

The prior art CRT type digital television requires overall redesigning of the analog block board and the digital block board. Therefore, development man-hour and board mold cost is a big burden. An efficient board arrangement technique is provided to resolve this problem.

This is accomplished with a CRT type digital television in which an analog block board 10 and a CRT board 11 have fixed board arrangements used in combination with multiple digital block boards 12, by which the cost of developing an analog block board is reduced and focus is placed on developing a digital block board, thereby reducing development and mass production related costs. Regarding the board arrangement, a CRT board 11 is provided outside the analog block board 10 to eliminate the vacant area 11a, thereby down-sizing the analog block board 10.

The present application is based on and claims priority of Japanese patent applications No. 2004-102166 filed on Mar. 31, 2004, the entire contents of which are hereby incorporated by reference.

### BACKGROUND OF THE INVENTION

1. Field of the Invention

The present invention relates to a circuit board arrangement technique for CRT type digital televisions which functionally divide and efficiently arrange an analog block board, a CRT board, and a digital block board, thereby reducing development and production costs.

2. Description of the Related Art

In the prior art, as shown in FIG. 6, a cathode ray tube (hereafter termed CRT) board 11 is formed within the area of an analog block board 10. After electronic elements are mounted and the CRT board 11 is cut out of the analog block board 10, both boards 10 and 11 are installed in a CRT type digital television, the analog block board 10 being provided with a cut-out, vacant area 11a in which no electronic parts can be mounted. Since the analog block board 10 includes the vacant area 11a, the area of only the CRT board 11 has a larger apparent area.

The analog block board 10 arranges a power block 14 for supplying electric power to all of the blocks, including a juxtaposed digital block board 12, an analog tuner 24a for converting and outputting received analog signals to intermediate frequency signals, an analog processing block 19 for processing video signals, a sound amplification block 16 for amplifying audio signals, a deflection block 15 for supplying high voltage to the CRT and for deflecting CRT electronic beams, an operation block 17 where main unit keys operated by viewers and a remote control light reception part are provided, and an analog control block 20 for communicating with a digital control block 21 provided on the juxtaposed digital block board 12 and for controlling the entire analog block.

FIG. 6 is further explained. The digital block board 12 juxtaposed with the analog block board 10 arranges, on a single multilayer board, a digital control block 21 for communicating with the analog control block 20 and controlling an MPEG (Moving Picture Experts Group, used for the compression and decompression of motion pictures and sound) block 22, for converting an MPEG Transport Stream (hereafter termed TS) from a demodulation block 23 to analog signals, a demodulation block 23 for demodulating digitally broadcast intermediate frequency (hereafter termed IF) signals to MPEG TS signals, and a digital tuner 24b for converting received digital signals to intermediate frequency signals and outputting them.

The prior art CRT digital television having the arrangement described above comprises a set of an analog board 10, a CRT board 11, and a digital block board 12. In order to design a new CRT type digital television, the analog block board 10, CRT board 11, and digital block board 12 are all redesigned for the intended specification. Extra wiring circuits are provided on a single board for multiple potential functional variations wherever possible, reducing development man-hour and mold costs. Considering the technical innovation of digital electronic parts, such as the incorporation of television microcomputers and analog signal processing parts, into MPEG ICs, all of the boards including the analog block board in the prior art board configuration described above must be redesigned in accordance with the advanced functions of MPEG ICs, in other words each time the MPEG ICs are modified.

Prior art technologies relating to digital television board arrangements are disclosed in Patent Documents 1 and 2 below.

Patent Document 1:

Japanese Laid-Open Patent Application Publication No. 2003-61009.
   Patent Document 2:
Japanese Laid-Open Patent Application Publication No. 2000-299576.

### SUMMARY OF THE INVENTION

In the prior art CRT type digital televisions, the analog block board, CRT board, and digital block board are all reviewed and redesigned for optimal arrangement each time the specification is changed in accordance with technical innovations of the main components of the digital circuits, such as MPEG ICs, through regular reviews or new development. Where possible, extra wiring circuits are provided on a single board for multiple potential functional variations, reducing development man-hour and mold cost. Considering that television microcomputers and analog signal processing parts will be incorporated into PMEG ICs to reduce costs in the future, all boards, including the analog circuits in the prior art board configuration described above, must be redesigned each time the MPEG ICs are modified. Therefore, more man-hours and board mold costs are anticipated for developing a new board. Programs for devices to mount electronic parts may have to be changed in accordance with the new board arrangements. Pre-production man-hours accompanying the board changes are also a burden.

In the prior art CRT type digital television board arrangement, the CRT board 11 is formed by cutting it out of the analog block 10, as shown in FIG. 6. Consequently, the analog block board 10 has a cut-put vacant area 11a, where no electronic parts can be mounted. Since the analog block board 10 includes the vacant area 11a, it appears to be larger by only the area of the CRT board 11. The size of the CRT board 11 cannot be ignored in general CRT analog televisions. For example, the CRT board 11 occupies an area of approximately 5.5 cm×7 cm in a 24-inch CRT analog television. Therefore, the problem is observed in a CRT type digital television housing that wasted space occurs in the board arrangement, which is supposed to be compact.

The present invention is proposed in view of the problems described above, and has as its objective to provide a CRT type digital television board arrangement in which a digital block board can accommodate future anticipated frequent specification changes in accompanying technical innovation, in which a technically matured analog block board, and a CRT board are functionally divided, the analog block board and CRT board having fixed specifications, effectively serving as common boards used in combination with a variety of digital block boards, in which the developmental focus is on a digital block subject to frequent specification changes in the future, reducing development man-hours, mold costs and the maintenance work load. Another purpose of the present invention is to improve the arrangement of the analog block board and CRT board comprising a single-sided board to reduce the analog block board area.

According to claim 1 of the present invention, the board arrangement is characterized by the fact that an analog block board, or a first board, arranges a deflection block, a sound amplification block, and an operation block in addition to a power block for supplying electric power to all of the blocks and serve, together with a second board, or a CRT board, as common boards used in combination with third, fourth, fifth, . . . digital block boards designed or selected for particular CRT type digital television functions.

A nearly rectangular multilayer digital block board, or the third, fourth, fifth, . . . boards, according to claim 2 of the present invention arranges an analog signal processing block, a digital control block, an MPEG block, a demodulation block, and a digital/analog tuner as appropriate, in combination with the first and second boards.

The analog block board, or the first board, according to claim 3 of the present invention has a nearly L-letter shape, and the CRT board, or the second board, is a small, nearly rectangular board formed adjacent to the first board. The two boards are arranged to form a set, another set of the first and second boards being arranged in a diagonally opposite manner is provided on a single-sided board to make a pair, the individual boards being separated from the single-sided board and one each of the first boards and the second boards being used for a CRT television.

With the arrangement according to claim 1 of the present invention, the first and second boards are fixed, common boards. A nearly rectangular multilayer digital block, or the third, fourth, fifth, . . . boards, arrange an analog signal processing block, a digital control block, an MPEG block, a demodulation block, and a digital/analog tuner as appropriate, making highly focused development available, and improving development and production efficiency. There is no need to create expensive molds for both the analog block board and the digital block board as was required in the prior art. Development man-hours, mold costs, and pre-production costs accompanying changes in programs for devices to mount electronic components are reduced, therefore reducing the total cost.

The analog block board, or the first board, and the CRT board, or the second board, have fixed wiring circuits, and the electronic components to be mounted are nearly fixed. The developmental focus is on a digital block board having the arrangement according to claim 2, used in combination with the first and second boards. In the prior art, both an analog block board and a digital block board are provided with extra wiring circuits for multiple potential functional variations in designing a new CRT type digital television. According to the board arrangement of the present invention, at least only the digital block board is provided with extra wiring circuits, and the area on the analog block board where extra wiring circuits are provided can be eliminated. The fact that the analog block board has a fixed board arrangement leads to the digital block board having a simplified board arrangement. Therefore, the digital block board formed by an expensive multilayer board can be reduced in size and its assembly facilitated.

According to claim 3 of the present invention, a nearly L-letter shaped analog block board is used as the first block, a CRT board is used as the second board, and the first and second boards are arranged adjacent to each other. In a diagonally opposite manner, another set of the first and second boards is arranged to make a pair on a single-sided board. The individual boards are separated from the single-sided board, with one each of the first and second boards being usable in a CRT type digital television. In this way, the analog block board does not have a vacant area as a result of cutting out a CRT board, as is in the prior art arrangement of FIG. 6. The analog block board can be reduced in size by the vacant area and its assembly can be facilitated. The digital block board according to claim 3, formed in a nearly rectangular shape as is in the prior art, can be arranged adjacent to the recessed part of the nearly L-letter shaped analog block. The planar occupancy within the housing of a CRT type digital television can be also reduced. Consequently, more options are available in arranging the boards.

### BRIEF DESCRIPTION OF THE DRAWINGS

FIG. 1 is an illustration showing an embodiment of the board arrangement of a CRT type digital television of the present invention that is of a universal type and which executes a modest amount of analog processing.

FIG. 2 is an illustration showing an embodiment of the board arrangement of a CRT type digital television of the present invention that emphasizes an analog processing function such as one with an audio performance emphasized specification.

FIG. 3 is an illustration showing an embodiment of the board arrangement of a CRT type digital television of the present invention in which an analog processing function is built into MPEG ICs.

FIG. 4 is an illustration showing an embodiment of the board arrangement of a CRT type digital television of the present invention in which analog block boards and CRT boards are arranged on a single-sided substrate.

FIG. 5 is an illustration showing an embodiment of the board arrangement of a CRT type digital television of the present invention in which a digital block board is arranged on a multilayer substrate.

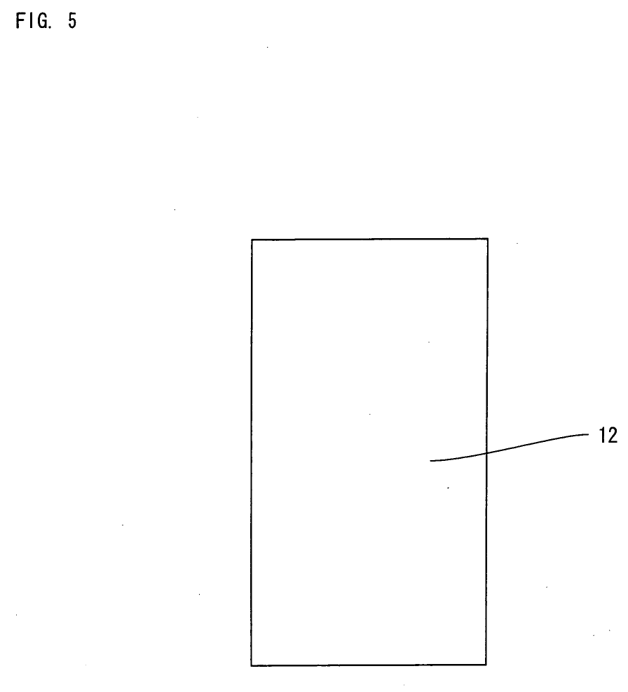

FIG. 6 is an illustration showing a prior art board arrangement of a CRT type digital television.

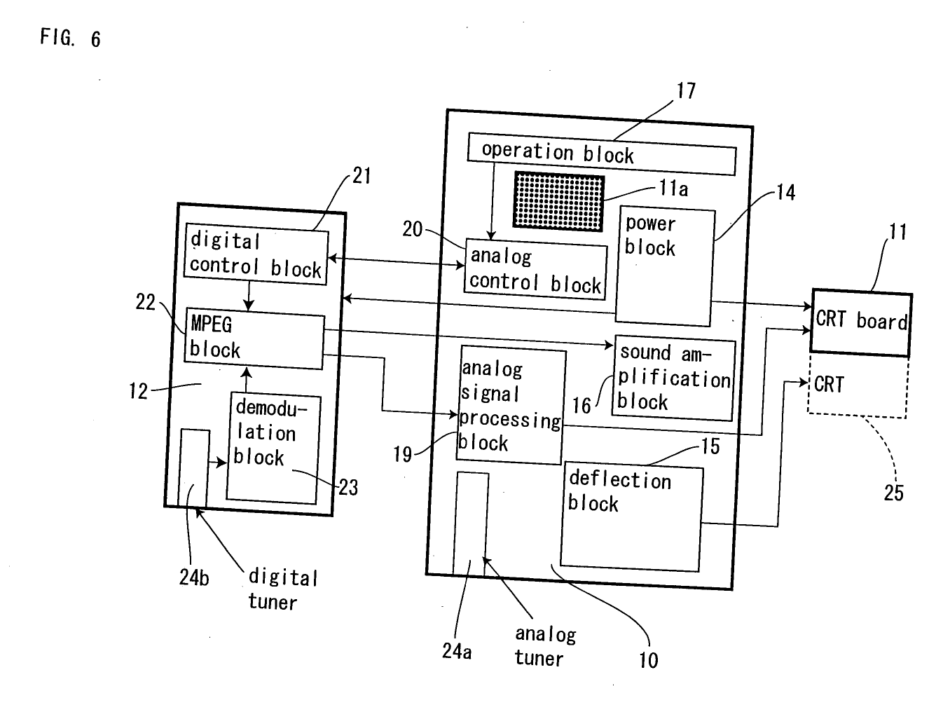

### DETAILED DESCRIPTION OF THE PREFERRED EMBODIMENTS

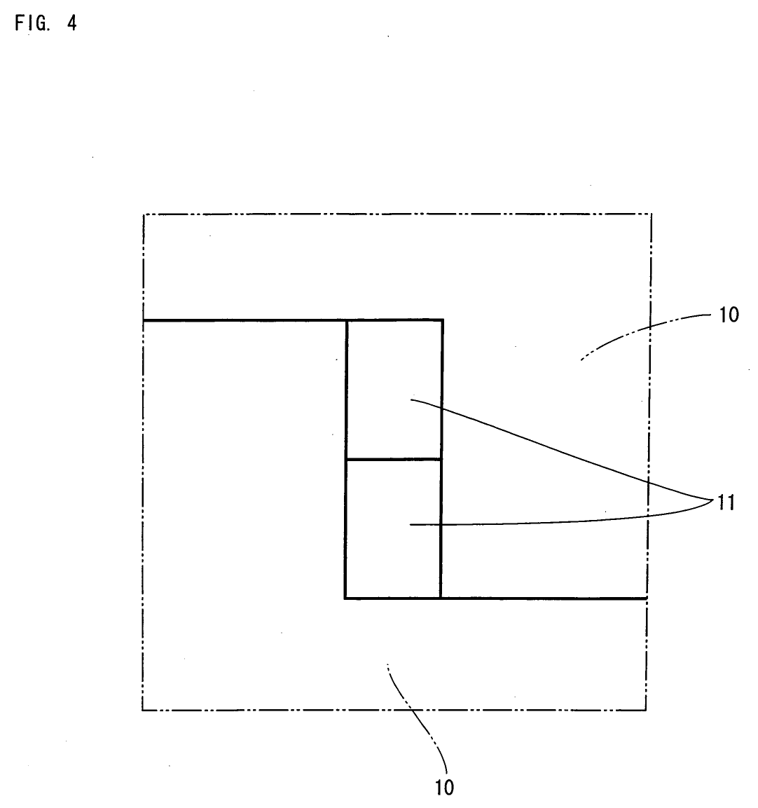

Preferred embodiments of the present invention are described hereafter, with reference to the drawings. In FIG. 4, a nearly L-letter shaped analog block board 10, or the first board, and a CRT board 11, or the second board, arranged in the recessed part of the nearly L-letter shape of the first board are arranged adjacent to each other. In a diagonally opposite manner and in a similar figure, another set of the first and second boards is arranged to create a pair on a single-sided board. The individual boards are separated from the single-sided board, with each being useable for a CRT type digital television.

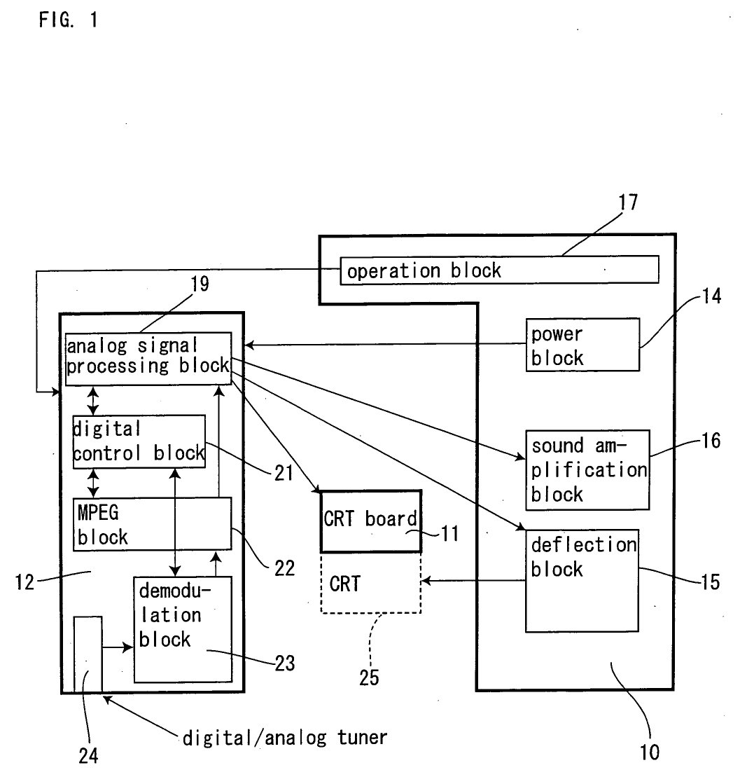

In this way, the analog block board does not have a vacant area 11a as a result of cutting out the CRT board, as is in the prior art arrangement. The external dimensions of the analog block board 10 can be reduced by size of the vacant area. For example, the CRT board 11 occupies an area of approximately 5.5 cm×7 cm in a 24-inch CRT analog television. The analog block board 10 can be reduced in terms of outside dimensions by this area, which otherwise creates the vacant area 11a. In FIG. 1, one end of the nearly L-letter shape is extended, where the operation block 17a for a CRT type digital television is provided. The main unit keys operated by viewers and the remote control light reception component can be provided in a horizontally extended area. Therefore, the keys (not shown) provided on the front of a CRT type digital television can be made easier to operate. In addition, the nearly L-letter shape has a deep recess, in which the digital-block board 12 can be efficiently provided.

FIG. 1 shows an embodiment of the board arrangement of a universal type CRT type digital television and executes a modest amount of analog processing in which an analog block board 10 and a CRT board 11 are common boards, arranges in combination with a digital block 12. The digital block 12, which is a third board on a multilayer board, arranges an analog signal processing block 19 for processing video signals, a digital control block 21 for communicating with the analog signal processing block 19 and for controlling an MPEG block 22, which converts MPEG TS signals from a demodulation block 23 to analog signals, the demodulation block 23 for demodulating digital broadcast IF signals to MPEG TS signals, and a digital/analog tuner 24 for converting digital/analog signals received to intermediate frequency signals and outputting them.

As described above, in the embodiment of the present invention, the analog block board 10 and CRT board 11 has a fixed board arrangement, eliminating the development cost of the analog block. Therefore, a greater variety of digital board arrangements will be developed, which has heretofore been avoided because of the high cost of the prior art. In the board arrangement of the universal type CRT type digital television, a modest amount of analog processing is executed in this embodiment, and an analog signal processing block 19 having a low analog signal processing ability and a relatively high versatility is provided on the digital block 12. Consequently, the cost of electronic components on the board can be reduced and efficient board mounting is ensured.

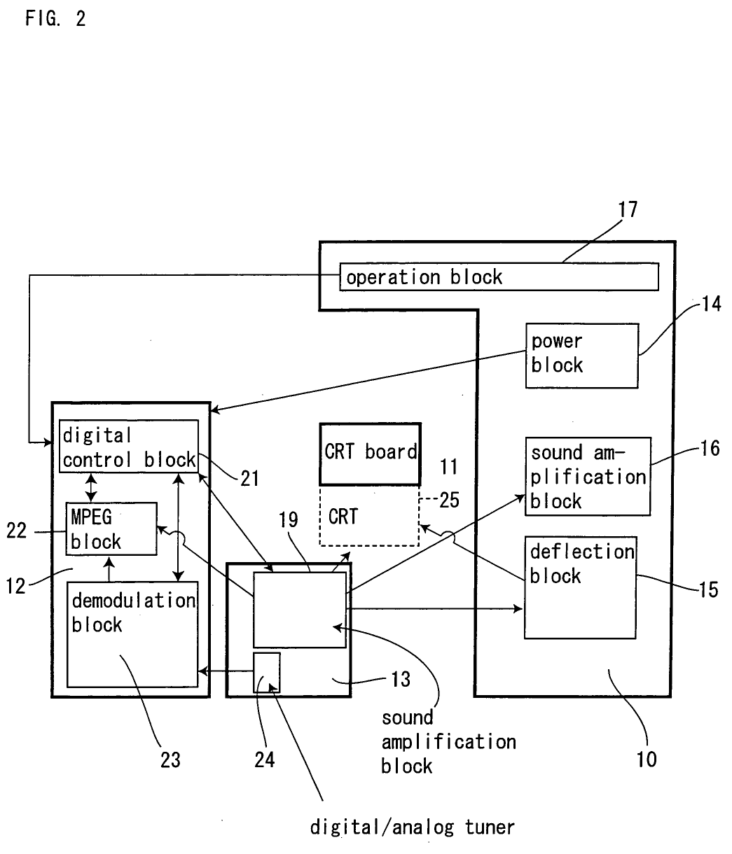

FIG. 2 shows another embodiment of a board arrangement in which an analog block board 10 and a CRT board are common boards and, in combination with which a digital block board 12 is provided. On the digital block board 12 comprising a fourth board, the CRT type digital television board arrangement is provided with a digital control block 21 for communicating with an analog signal processing block 19 on a fifth board, described later, and controlling an MPEG block 22, an MPEG block 22 for converting MPEG TS signals from a demodulation block 23 to analog signals, and a demodulation block 23 for demodulating digital broadcast IF signals to MPEG TS signals and, on the fifth board, an analog signal processing block 19 for processing video signals and a digital/analog tuner 24 for converting received digital/analog signals to intermediate frequency signals and outputting them.

This board arrangement focuses on analog processing, such as for use with audio performance emphasized specifications. The analog signal processing block 19 is not expanded on the digital block board, which is an expensive multilayer board, but is instead provided on a fifth board, which is an inexpensive, single-sided board, together with the digital/analog tuner 24. Consequently, audio emphasized CRT type digital televisions can be supplied to audio maniac customers at low cost.

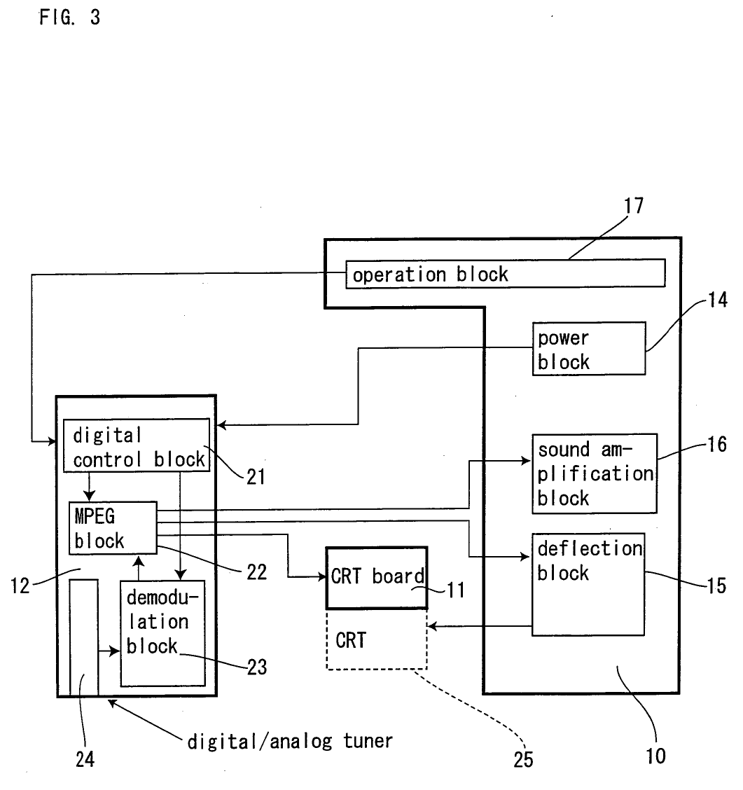

In addition, FIG. 3 shows an embodiment of aboard arrangement in which it is assumed that MPEG ICs constituting a MPEG block 22 will encompass analog processing functions in the near future. This board arrangement comprises an analog block 10 and a CRT board 11 that are common boards according to the present invention and, in combination with a digital block board 12, or a sixth board, carrying a digital control block 21 for communicating with and controlling an MPEG block 22 having analog signal processing functions, described later, the MPEG block 22 is provided with an MPEG ICs having analog processing functions, a demodulation block 23 for demodulating digital broadcast IF signals to MPEG TS signals, and a digital/analog tuner 24 for converting digital/analog signals received to intermediate frequency signals and outputting them. When MPEG ICs having analog processing functions are used, the analog signal processing block is unnecessary. A sixth board comprising a multilayer board, can be made smaller than the third board.

Embodiments of the present invention are described in detail above. The present invention is not confined to these embodiments and various modifications can be made within the scope of the present invention. For example, a seventh board (not shown) carrying an analog tuner and an analog signal processing block on a single-sided substrate can be used in combination with the first board, or an analog block board, and the second board, or a CRT board to create a CRT analog television. Alternatively, a CRT board, or second board, is provided on a nearly L-letter shaped analog block board, or first board, at one end and another set of the first and second boards is provided in a diagonally opposite manner and in a similar figure to create a pair on a single-sided substrate (not shown) The embodiments above are not restrictive and choices are made as appropriate.

1. A CRT type digital television characterized by a board arrangement in which an analog block board, or a first board, arranges a deflection block, a sound amplification block, and an operation block in addition to a power block for supplying electric power to all of the blocks, wherein said first board and a second board, or a CRT board, are common boards used in combination with the third, fourth, fifth, . . . digital block boards designed or selected for particular CRT type digital television functions.

2. The CRT type digital television according to claim 1 characterized by a board arrangement in which a nearly rectangular multilayer digital block board, or said third, fourth, fifth, . . . boards, arrange an analog signal processing block, a digital control block, an MPEG block, a demodulation block, and a digital/analog tuner as appropriate and is used in combination with said first and second boards.

3. The CRT type digital television according to claims 1 and 2 claim 1, characterized by a board arrangement in which said analog block board, or the first board, has a nearly L-letter shape and said CRT board, or the second board, is a small, nearly rectangular board formed adjacent to said first board, the two boards being arranged to make a set, and another set of said first and second boards arranged in a diagonally opposing manner is provided on a single-sided board to make a pair, the individual boards being separated from the single-sided board, and one each of said first boards and said second boards being used for a CRT type digital television.

4. The CRT type digital television according to claim 2, characterized by a board arrangement in which said analog block board, or the first board, has a nearly L-letter shape and said CRT board, or the second board, is a small, nearly rectangular board formed adjacent to said first board, the two boards being arranged to make a set, and another set of said first and second boards arranged in a diagonally opposing manner is provided on a single-sided board to make a pair, the individual boards being separated from the single-sided board, and one each of said first boards and said second boards being used for a CRT type digital television.
